(19) United States
(12) Patent Application Publication
(10) Pub. No.: US 2005/0039785 A1
(43) Pub. Date: Feb. 24, 2005

(54) Paint roller cleaning and conditioning tool

(76) Inventor: Curtis Nordmark Knowles, Apple Valley, MN (US)

Correspondence Address: Curtis N. Knowles, 15114 Dundee Avenue, Apple Valley, MN, 55124, US

(21) Appl. No.: 10/642,570

(22) Filed: Aug. 18, 2003

(51) Int. Cl. B08B 3/02

(52) U.S. Cl. 134/137; 134/149; 134/157; 134/140; 134/900

(57) ABSTRACT

A tool for facilitating the cleaning of paint roller covers by providing a quick and convenient connection between the roller cover to be cleaned and an ordinary hand-held electric drill. The roller cover is attached to the tool which is chucked into the drill and spun at high rpm. The paint is removed by centrifugal force and recovered. The tool permits the easy exchange of roller covers of various lengths.

### CROSS REFERENCE TO RELATED APPLICATIONS

“Not Applicable”

### STATEMENT WITH REGARDS TO FEDERALLY SPONSORED RESEARCH OR DEVELOPMENT

“Not Applicable”

### REFERENCE TO A “MICROFICHE” APPENDIX

“Not Applicable”

### BACKGROUND OF THE INVENTION

Paint rollers are in widespread use by homeowners and “do it your selfers as well as by professional painters to apply various kinds of paints. Since the rollers are generally well made they are capable of reuse after cleaning, but this is a rather messy and time consuming job. This tool greatly simplifies that job in addition it allows the user to recycle the paint left in the roller and enhance the performance of a new roller before its first use.

### BRIEF SUMMARY OF THE INVENTION

It is an object of this invention to enable a paint roller to be thoroughly and quickly cleaned in an efficient manner with a minimum of mess and a minimum expenditure of time and effort.

It is a further object of this invention to provide a tool which is adapted to be used with ease in conjunction with an ordinary electric hand drill of the type used by many “do it your selfers” and others without modification of the drill.

It is a further object of this invention to provide a tool which can readily be adapted to clean paint rollers of different lengths by providing for the ease in exchanging the roller cover support from one length to another to accommodate roller covers of varying lengths.

It is a further object of this invention to provide a tool which can be used to clean a roller cover having a “NAPCAP”™ end cover of the type disclosed in my U.S. Pat. No. 5,613,264 installed thereon without the necessity of removing the end cap to clean both the roller cover and the end cap simultaneously.

It is a further object of this invention to provide a tool which can be used to easily recycle a considerable amount of paint from the roller especially with longer length naps by spinning it back into a paint pail.

It is a further object of this invention to provide a tool which can be used to precondition a new roller by enhancing its performance when it is rinsed and spun out. This will flush out the “fuzz” and “cut” fibers that are left in the roller in the manufacturing process even after they were vacuumed. It will also tend to spread the fibers in the nap enabling the roller to hold much more paint.

### BRIEF DESCRIPTION OF THE DRAWINGS

FIG. 1 is a side elevation view of the cleaning tool.

FIG. 2 a side elevation view of the cleaning tool with the roller cover support removed.

FIG. 3 is a side elevation view of the cleaning tool showing the sleeve guide.

FIG. 4 is a side elevation view of the cleaning tool showing a variation of FIG. 2 and FIG. 3

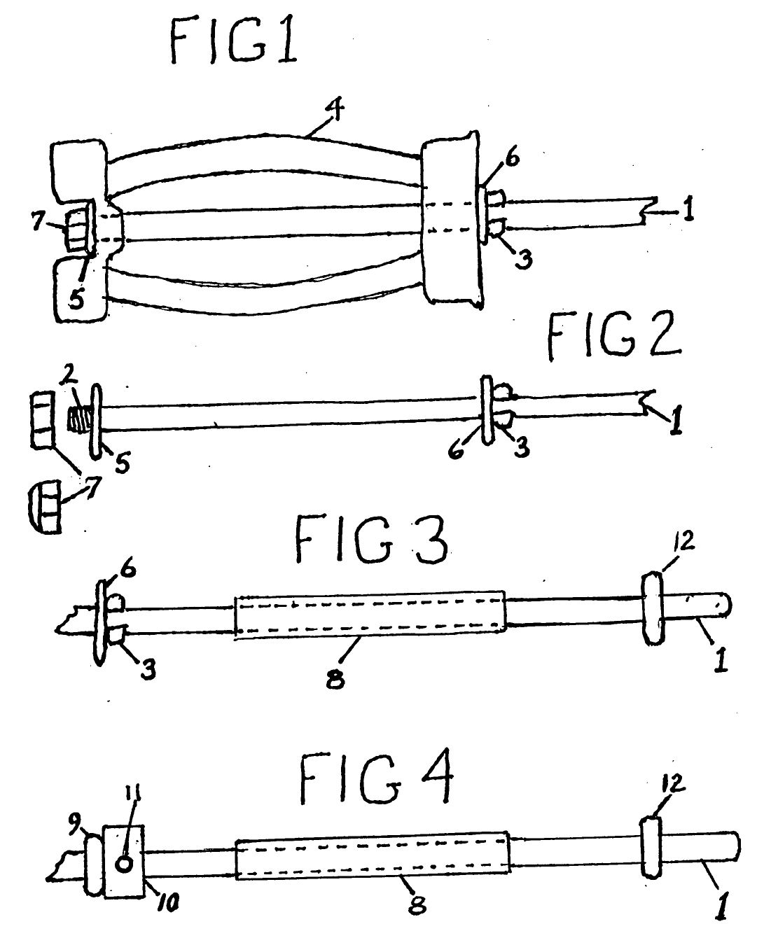

### DETAILED DESCRIPTION OF THE DRAWINGS

The preferred embodiment of the invention consists of a shaft 1, threaded at one end 2, and having a protuberance 3, located on the shaft 1, at a distance from the threaded end 2, which distance is slightly greater than the length of the roller cover to be cleaned. This protuberance can preferably be in a form of a pair of stamped “ears”. A cylindrical paint roller cover support 4, is held in place between two washers 5, and 6, by a nut 7, which forces the cylindrical paint roller cover support 4, against the protuberance 3, and couples the cover support 4, to the shaft 1, by compressing the cover support 4, into frictional engagement between the protuberance 3, the washers 5, and 6, and the nut 7. The roller cover support is preferably a standard paint roller of conventional construction. I have illustrated a roller of a “cage” or open wire type construction, but other types of conventional construction can be used. If desired, the nut 7, can be a locking cap nut, or a drop of thread locking compound can be applied to hold the nut in place. A guide sleeve 8, is slipped over the shaft 1, between the drill chuck and the roller cover support 4, to serve as a means to be grasped by the users hand to guide and support the shaft 1. In the modified form of the invention shown in FIG. 4, a collar 10, is held in place by a set screw 11, and an “O” ring 9, are used in place of the “ears” 3, and washer 6, to form the “protuberance” . Thus the roller cover support can be easily be exchanged for one of a different length so the tool can be used with paint rollers of different lengths; i.e., the commonly used 4, 7, and 9 inch sizes as well as other sizes. A guide sleeve 11, is loosely slipped over the shaft 1, between the drill chuck and the roller cover support means 4, to serve as a means to be grasped by the users hand to support and guide the shaft 1, during use. the sleeve 11, is held in place by an “O” ring 12 .

In use, the roller to be cleaned is placed on the shaft and chucked into an electric hand drill. the roller is now inserted into the open end of a paper bag, box or pail, the drill is actuated and the paint is spun out of the roller in seconds. the roller is then soaked in solvent and flushed clean while spinning dry in seconds.

1. A paint roller cover cleaning tool adapted for use in cleaning paint roller covers by conveniently connecting them to commonly used hand held electric drills for cleaning them by spinning comprising: a shaft having two ends, said shaft threaded at a first end, a roller cover support means adapted to support a conventional tubular paint roller cover thereon mounted on said shaft and extending axially there along, a protuberance means located on said shaft at a distance from said first end which is greater than the axial length of said roller cover support means, and a compressing means on said threaded end of said shaft forcing said roller cover support means into frictional engagement with said protuberance means for coupling said roller cover support means to said shaft for rotation therewith when said second end of said shaft is connected to an electric drill.

2. A Paint roller cover cleaner tool as in claim 1 and further including a guide sleeve loosely slipped over the shaft between the roller cover support means and the second end of the shaft and held in place by a retaining means.
